(19) United States
(12) Patent Application Publication
(10) Pub. No.: US 2017/0132992 A1
(43) Pub. Date: May 11, 2017

(54) APPARATUS AND METHOD FOR IMPARTING ACOUSTIC EFFECT TO PIANO

(71) Applicant: Ursula Caporali, Leichhardt (AU)

(72) Inventor: Ursula Caporali, Leichhardt (AU)

(21) Appl. No.: 15/127,853

(22) PCT Filed: Mar. 19, 2015
(86) PCT No.: PCT/AU2015/050117

§ 371 Date: Sep. 21, 2016

(30) Foreign Application Priority Data
Mar. 24, 2014 (AU) 2014901032

(51) Int. Cl. G10C 3/26; G10C 3/20

(52) U.S. Cl. CPC G10C 3/26; G10C 3/20

(57) ABSTRACT

An acoustic effect impartment apparatus for use in a piano including a plurality of keys, a plurality of strings provided in corresponding relation to the keys and a plurality of hammers each responsive to an operation of any one of the keys to strike the string corresponding to the key. The acoustic effect impartment apparatus comprising at least one elongate member disposed near at least one of the plurality of strings. The elongate member movable by means of a first actuator between a retracted configuration in which the elongate member is disengaged away from the at least one of the plurality of strings and an imparted configuration wherein the elongate member is imparted against the at least one of the plurality of strings, and the first actuator can be actuated by a piano player such that the elongate member is imparted against the at least one of the plurality of strings as said piano player strikes a key associated therewith.

### TECHNICAL FIELD

The present invention relates to apparatus and method for imparting an acoustic effect to a piano. In particular the invention is described with reference to an elongate member (or finger) which can be actuated by a piano player to engage with a string of an acoustic piano as the hammer strikes the string, in order to create a harmonic. The elongate member can be moved relative to a plurality of strings in the piano by the piano player, so that it can be selectively imparted against the strings.

### BACKGROUND

In the field of acoustic pianos it is known to employ unorthodox or unconventional techniques, sometimes referred to as “piano extended techniques” to create the sound. One such technique is referred to as the “flageolet technique”, which is the creation of harmonics by touching overtone positions on a piano string with the finger of one hand and hitting the respective key with the other hand.

This “flageolet technique” commonly used for bowed strings on all instruments of the violin family allows for direct access to harmonics as principal or ground tones. A slight touch of a string prevents strings motion at the touching point, but does not clamp the string. The result is the sound of a half wave length. This technique has been used to access high ranging notes. The “flageolet technique” allows a stringed instrument or piano to produce an eerie sound of a wind instrument like, “flautando” quality. It is for this reason the technique is named “flageolet” which is the name of a French woodwind instrument of the flute family.

Flageolet sounds can be produced on a grand piano, touching the strings slightly either before or after hitting the respective key. Whilst a piano player can create a flageolet sound or other alternative sound by touching a piano string with a finger of one hand and hitting the respective key with the other hand, there are limitations to use of the technique in musical compositions, as the piano player must move one of his hands away from the keyboard to touch the string, and in order to do so must stand, and therefore cannot remain seated to create a flageolet sound.

As such the “flageolet sound”, alternative sounds and other harmonic effects, are difficult to achieve, when relying on the piano player touching the strings.

It is also disadvantageous for a piano player to continually touch metal piano strings, as sweat and other secretions, such as oil and salt on the hands and fingers can cause oxidation and corrosion of the strings. As such it is desirous to not have a piano player touch piano strings.

As such it is desirous to have a means of creating the flageolet sound, alternative sound or other harmonic effect in a piano, where such sound can easily be employed in a musical composition and does not require the piano player to touch the piano strings.

The present invention seeks to overcome at least one of the disadvantages of the prior art, by providing apparatus and method for imparting an acoustic effect to a piano.

### SUMMARY OF INVENTION

According to a first aspect the present invention consists of an acoustic effect impartment apparatus for use in a piano including a plurality of keys, a plurality of strings provided in corresponding relation to said keys and a plurality of hammers each responsive to an operation of any one of said keys to strike the string corresponding to the key, said acoustic effect impartment apparatus comprising:

at least one elongate member disposed near at least one of said plurality of strings, said elongate member movable by means of a first actuator between a retracted configuration in which said elongate member is disengaged away from said at least one of said plurality of strings and an imparted configuration wherein said elongate member is imparted against said at least one of said plurality of strings, and said first actuator can be actuated by a piano player such that said elongate member is imparted against said at least one of said plurality of strings as said piano player strikes a key associated therewith and wherein at least one track disposed relative to and spaced apart from said plurality of strings, a carriage mounted to said track and slidably movable therewith, said carriage supporting said elongate member, and said carriage slidably movable along said track by means of a second actuator.

Preferably said elongate member has a free end, and when said elongate member is imparted against said at least one of said plurality of strings, it is said free end that is imparted therewith.

Preferably at least a portion of said free end of said elongate member comprises an elastomeric material.

Preferably said first actuator is operably connected to a first pedal.

Preferably said first pedal is operably connected to said first actuator via mechanical means or electromechanical means.

Preferably in one particular embodiment said mechanical means is a cable means.

Preferably in a further embodiment said second actuator is operably connected to a second pedal.

Preferably in an even further embodiment said second pedal is operably connected to said first actuator via mechanical means or electromechanical means.

Preferably in a further embodiment said second actuator is operably connected to a push button.

Preferably in another particular embodiment said first actuator can be actuated via wireless means.

Preferably in one arrangement said apparatus is built into said piano.

Preferably in another arrangement said apparatus is retrofitted to said piano.

Preferably in a further arrangement said apparatus is portable and removably fitted to said piano.

### BRIEF DESCRIPTION OF DRAWINGS

FIG. 1 is a perspective view of an acoustic effect impartment apparatus according to a first embodiment of the present invention fitted to a grand piano.

FIG. 2 is an enlarged perspective view of acoustic effect impartment apparatus shown in FIG. 1.

FIG. 3 is an enlarged partial elevation view of of an acoustic effect impartment apparatus according to a second embodiment of the present invention.

FIG. 4 is a perspective view of an acoustic effect impartment apparatus according to a third embodiment of the present invention.

FIG. 5 is a schematic of a piano string that has a finger of an acoustic effect impartment apparatus, such as in the first embodiment shown in FIG. 1 imparted against it as a hammer strikes the piano string.

### DESCRIPTION OF PREFERRED EMBODIMENTS

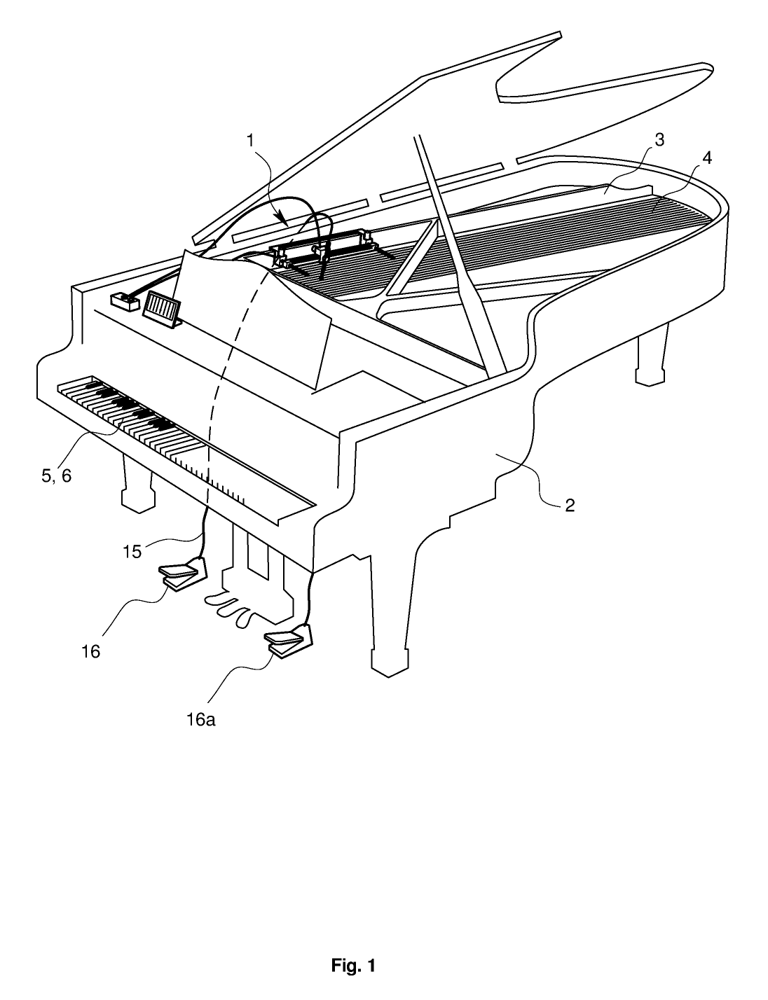

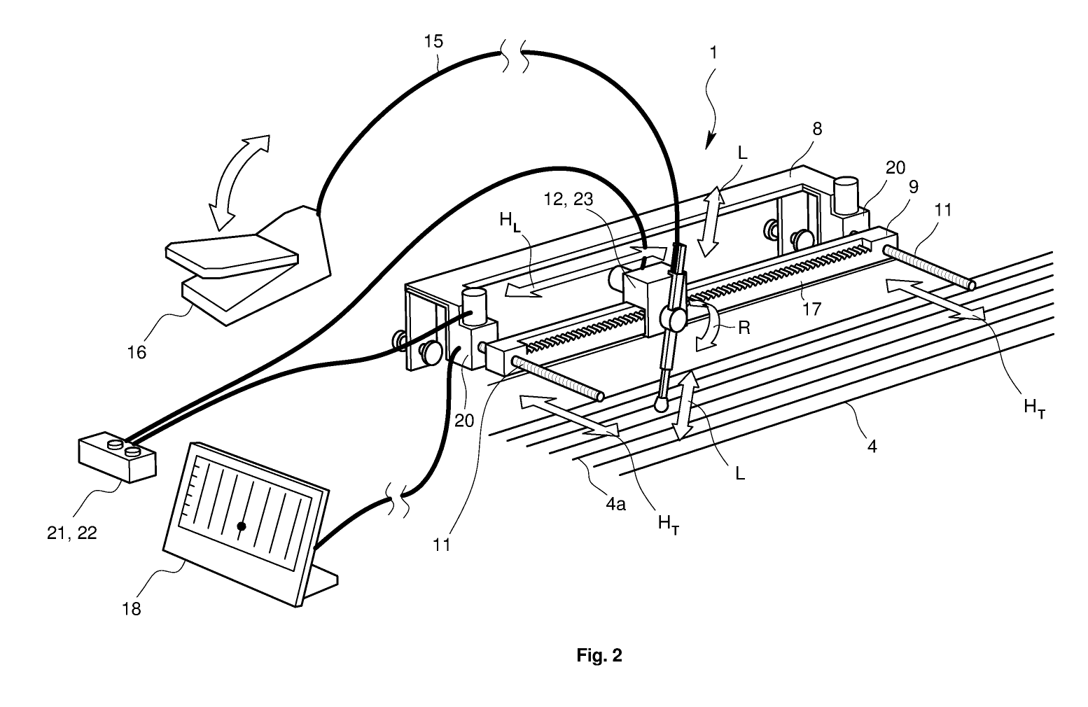

FIGS. 1 and 2 depict an “acoustic effect” impartment apparatus 1 according to a first embodiment of the present invention :fitted to a piano 2. By “acoustic effect” we mean that apparatus 1 is for altering the sound created by a conventional piano, so as to produce a flageolet sound, alternative sound or a harmonic effect in addition to traditional sounds generated by piano 2.

Piano 2 is a conventional grand piano, having an internal metal frame 3 and strings 4 disposed horizontally, with strings 4 extending away from keyboard 5 having a plurality of keys 6, each associated with a particular string 4. The strings are conventionally of varying thickness metal wire, with the lowest notes produced by strings to left of the keyboard.

When a key 6 is struck it results in a hammer (not shown) striking the associated string 4 and causing it to resonate, by means of a conventional lever/damper arrangement, details of which are well known to those skilled in the art of pianos.

Apparatus 1 comprises a support frame 8 mountable to frame 3 of piano 2. Support frame 8 has two horizontally extending spaced apart guide rods (tracks) 11 supporting a first carriage 9 that can move horizontally in a transverse direction over strings 4, as shown by double headed arrow H_{T}. First carriage 9 supports a second carriage 12, that can move horizontally in a linear direction parallel to strings 4 as shown by double headed arrow H_{L}. In this embodiment first carriage 9 and second carriage 12 engage in “rack and pinion” fashion, where a rack of teeth 17 on carriage 9 engage with a pinion (a hidden circular gear) mounted within second carriage 12, thereby allowing relative movement there between.

A finger 7 is disposed above and near strings 4 and supported by second carriage 12. In this specification and in relation to the apparatus 1, “finger” is not used to mean an articulated knuckle member similar to a human's finger, but rather an “elongate member”. Preferably finger 7 has free end (or head) 14 made of, or coated with, an elastomeric material such as rubber, silicone or the like.

A cable 15, which may for example be a “Bowden cable” extends between a pedal 16 and finger 7, and can be used to transmit a “pulling or pushing force” to move finger 7 between a retracted configuration in which finger 7 is disengaged away from a string 4a to an imparted configuration where finger 7 is imparted against 4a. Cable 15, can be actuated by a piano player (not shown) such that finger 7 imparts string 4a as the piano player strikes a key 6 associated therewith. The motion of finger 7 may be rotational, as shown by arrow R or linear as shown by double headed arrow L, or a combination of both in order to move finger 7 between the “retracted configuration” and the “imparted configuration” as shown in FIG. 2.

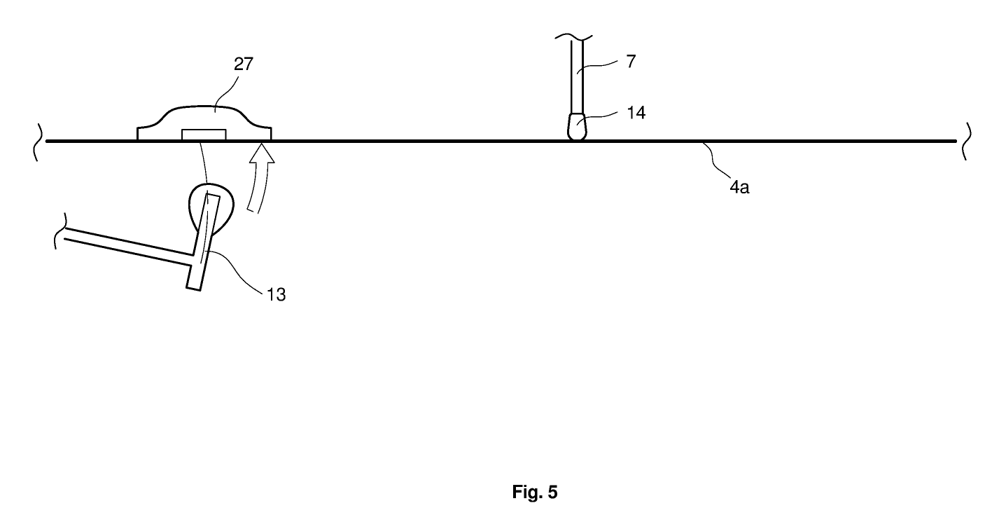

By imparting finger 7 against string 4a, either before or simultaneously with hitting respective key 6, a “harmonic effect” can be created, similar to that achievable by a piano player touching string 4. FIG. 5 depicts head 14 of finger 7 as it imparts against string 4a in the “imparted configuration” and hammer 13 (associated with a key 6 not shown in FIG. 5) is moving towards string 4a near damper 27.

First carriage 9 can preferably be moved horizontally in a transverse direction over strings 4, as shown by double headed arrow H_{T}, by means of an electro-mechanical actuator 20, and this movement maybe actuated by the piano player (not shown). The transverse position of finger 7 relative to strings 4 could be monitored using an indicator means 18 operably connected to electro-mechanical actuator 20, which provides the piano player a visual indication as to which “string location” finger 7 is disposed at. In use, the piano player could actuate electro-mechanical actuator 20 using a push button trigger 21.

Movement of second carriage 12 relative to first carriage 9 as shown by double headed arrow H_{L} would move finger 7 along length of string 4a, thereby varying the “harmonic effect”. Likewise whilst finger 7 is imparted against string 4a, movement of carriage 12 relative to carriage 9 would drag finger 7 relative to string 4a, again causing a varied harmonic effect. In this embodiment push button 22 is used to actuate electro-mechanical actuator 23 to move first carriage 9.

In use apparatus 1 could be used to impart harmonic (acoustic) effects, including flageolet effects to any of strings 4. However, the most advantageous effects in pianos occur when finger 7 of apparatus are used on strings 4 for the lowest notes, namely those associated with keys 6 towards the left end of keyboard 5.

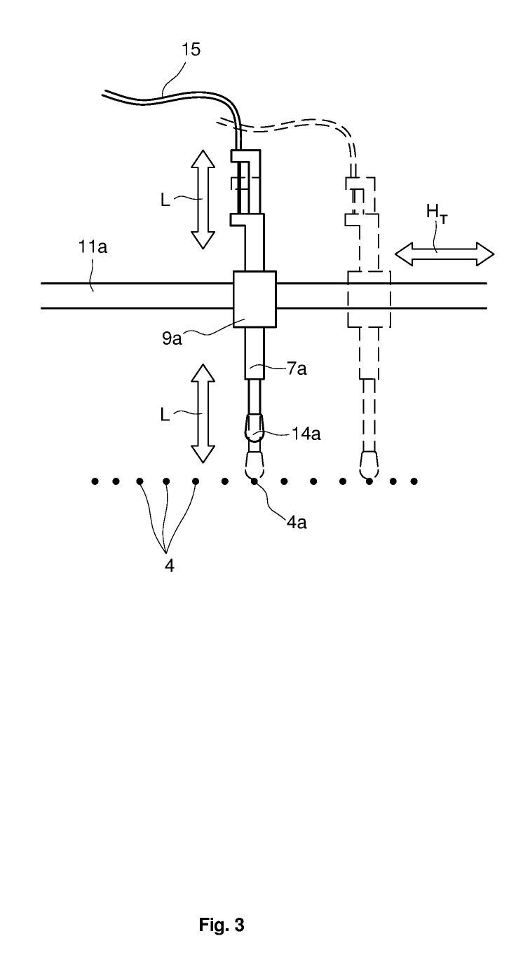

FIG. 3 depicts a second embodiment schematically, which is an alternative to the first embodiment. In this embodiment a rod (or rail/track) 11a similar to rod 11 is disposed transversely over strings 4. Rod 11a extends from a support frame (not shown) but similar to support frame 8 of the first embodiment. Carriage 9a is mounted on rod 11a so it that can move horizontally in a transverse direction over strings 4, as shown by double headed arrow

H_{T}. Finger 7a, having head 14a is mounted to carriage 9a and operably connected to a cable 15 (and actuated by a pedal (not shown), similar to the first embodiment. The motion of finger 7a is linear as shown by double headed arrows L, between the “retracted configuration” and the “imparted configuration” where it touches string 4a. A separate “imparted configuration” is also shown by the ghost line representation in FIG. 3. Please note that means for moving carriage 9a relative to 11a, has been omitted for clarity and ease of reference, but could either be a mechanical or electro-mechanical actuator, which is operated by the piano player (not shown).

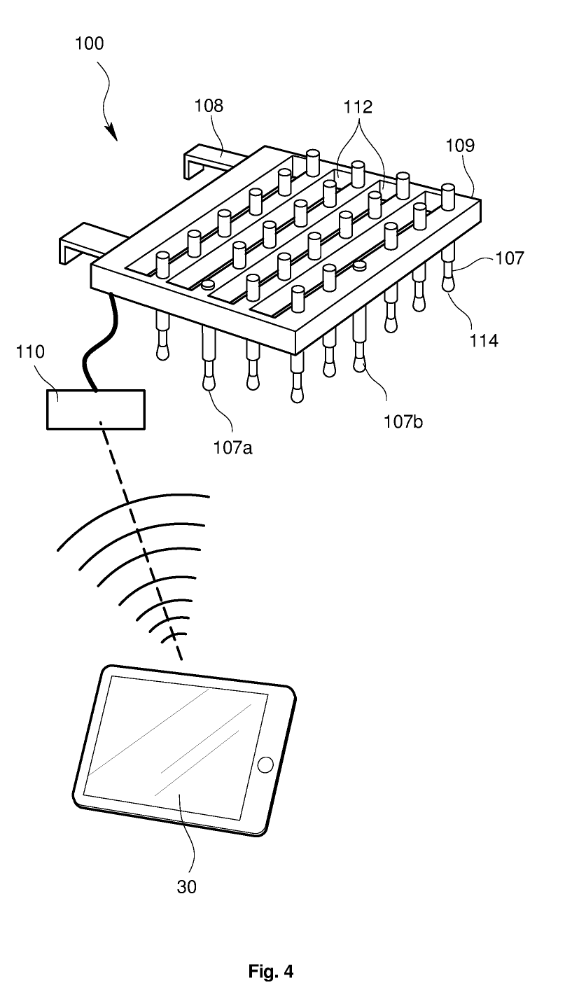

FIG. 4 depicts an acoustic effect impartment apparatus 100 according to a third embodiment of the present invention to be fitted to a piano (not shown). In this embodiment, apparatus 100 has a support frame 108 that allows it to be attached to the metal frame of the not shown piano. A finger support housing 109 supports a plurality of fingers 107 to be held in a grid (row/column) relationship above a plurality of strings of the piano. Finger support housing 109 has a plurality of elongate openings 112 between each column of finger 107.

Each of the fingers 107 can be individually actuated by an electro-mechanical means (not shown-hidden within frame 108) so that they can linearly move in a vertical direction downwardly from a “retracted configuration” to an “imparted configuration” where they touch the strings of the piano. In FIG. 4, fingers 107a and 107b are shown in the “imparted configuration”, whilst the remaining fingers 107 are in the retracted configuration. Like that of the first embodiment, the free ends (or head) 114 are made of, or coated with, an elastomeric material such as rubber, silicone or the like.

In this third embodiment, the selection of which finger 107 is to be imparted against a string (not shown) can be chosen via the “touch screen” of a wireless interactive device, such as a tablet computer 30 connected to said apparatus 100 via controller 110, and be actuated by same. However, it should be understood that the touch screen of tablet 30 could be used as the means of selecting a desired finger 107, and a pedal (not shown) in wireless communication with controller 110 could be used to actuate the selected finger 107.

In this third embodiment, twenty-four fingers 107 are shown. However, it should be understood that a different number of fingers 107 could be used. In an alternative not shown embodiment, housing 109 may be considerably smaller and could for example support a smaller number of fingers 107, say twelve fingers 107.

For illustrative purposes in the first embodiment, the actuation of finger 7 is shown as “mechanical action” via an “actuator”, namely the actuation of cable 15 using pedal 16, whilst actuation of electro-mechanical actuators 20, 23 is by push-buttons 21, 22. However, it should be understood that actuation of finger 7 could also be via an electro-mechanical actuator (not shown), which is also pedal actuated. Furthermore push-buttons 21, 22 could also be replaced or supplemented with a pedal 16a (see FIG. 1) for actuating electro-mechanical actuators 20,23. Furthermore any pedals or push buttons depicted in the first embodiment could be replaced by lever(s) operated by the knee(s) of the piano player.

Furthermore, in the first embodiment, second carriage 12 is in a geared rack and pinion relationship with first carriage 9. However, in another not shown embodiment second carriage 12 could be a slider mounted to a rail attached to or integral with first carriage 9. Likewise, the mechanical arrangement of first carriage 9 slidable along rods 11 could differ to that shown.

The important feature is that the carriage that supports the finger 7 is horizontally movable in a transverse manner over the strings of piano 2, and that finger 7 can be actuated by the piano player, either mechanically or electro-mechanically between the “retracted configuration” and the “imparted configuration” where finger 7 touches a string 4.

It should also be understood that in the first embodiment, wireless communication between pedals, buttons, levers could be used to acuate finger 7 via electro-mechanical actuators 20, 23. Alternatively, a tablet computer or other wireless device, similar to tablet 30 of the second embodiment could be used to identify and select the position of finger 7, and be used to actuate same.

In all of the abovementioned embodiments, it is preferable to use mechanical and/or electro-mechanical actuator components which are quiet during operation so as they do not impact acoustically on the playing of piano 2. They may require shrouding or insulation to minimise or eliminate noise during actuation, so that the only component of the apparatus imparting an acoustic effect is finger 7,107 when it touches a string 4.

It should be understood that the various abovementioned embodiments of the present invention, could be purpose built into a particular piano, or retrofitted thereto. It could also be provided with a mounting arrangement that is “universal”, meaning that it can be removably fitted to a range of pianos, and/or allowing it to be portable, therefore allowing a piano player to move it from piano to piano, as need be.

The embodiments of the present invention are advantageous over the prior art, because the piano player can generate “flageolet sound”, alternative sounds such as “damping of strings” and other harmonic effects, whilst remaining seated, and without touching the strings with his or her hands. This also means the piano player can generate these sounds whilst carrying out normal hand activity on the keyboard, thereby allowing composers to create new music compositions previously not possible, incorporating the sounds that are generated by the present invention along with those traditionally generated via the keyboard 5 of piano 2.

The terms “comprising” and “including” (and their grammatical variations) as used herein are used in an inclusive sense and not in the exclusive sense of “consisting only of”.

1. An acoustic effect impartment apparatus for use in a piano including a plurality of keys, a plurality of strings provided in corresponding relation to said keys and a plurality of hammers each responsive to an operation of any one of said keys to strike the string corresponding to the key, said acoustic effect impartment apparatus comprising:
at least one elongate member disposed near at least one of said plurality of strings, said elongate member movable by means of a first actuator between a retracted configuration in which said elongate member is disengaged away from said at least one of said plurality of strings and an imparted configuration wherein said elongate member is imparted against said at least one of said plurality of strings, and said first actuator can be actuated by a piano player such that said elongate member is imparted against said at least one of said plurality of strings as said piano player strikes a key associated therewith.

2. An acoustic effect impartment apparatus as claimed in claim 1, wherein said apparatus comprises at least one track disposed relative to and spaced apart from said plurality of strings, a carriage mounted to said rail and slidably movable therewith, said carriage supporting said first member, and said carriage slidably movable along said track by means of a second actuator.

3. An acoustic effect impartment apparatus as claimed in claim 1, wherein said elongate member has a free end, and when said elongate member is imparted against said at least one of said plurality of strings, it is said free end that is imparted therewith.

4. An acoustic effect impartment apparatus as claimed in claim 1, wherein at least a portion of said free end of said elongate material comprises an elastomeric material.

5. An acoustic effect impartment apparatus as claimed in claim 1, wherein said first actuator is operably connected to a first pedal.

6. An acoustic effect impartment apparatus as claimed in claim 5, wherein said first pedal is operably connected to said first actuator via mechanical means or electromechanical means.

7. An acoustic effect impartment apparatus as claimed in claim 6, wherein said mechanical means is a cable means.

8. An acoustic effect impartment apparatus as claimed in claim 2, wherein said second actuator is operably connected to a second pedal.

9. An acoustic effect impartment apparatus as claimed in claim 8, wherein said second pedal is operably connected to said first actuator via mechanical means or electromechanical means.

10. An acoustic effect impartment apparatus as claimed in claim 2, wherein said second actuator is operably connected to a push button.

11. An acoustic effect impartment apparatus as claimed in claim 1, wherein said first actuator can be actuated via wireless means.

12. An acoustic effect impartment apparatus as claimed in claim 1, wherein said apparatus is built into said piano.

13. An acoustic effect impartment apparatus as claimed in claim 1, wherein said apparatus is retrofitted to said piano.

14. acoustic effect impartment apparatus as claimed in claim 1, wherein said apparatus is portable and removably fitted to said piano.

15. An acoustic effect impartment apparatus for use in a piano including a plurality of keys, a plurality of strings provided in corresponding relation to said keys and a plurality of hammers each responsive to an operation of any one of said keys to strike the string corresponding to the key, said acoustic effect impartment apparatus comprising:
a housing including a support frame that allows it to be attached to said piano, a said housing supporting a plurality of fingers disposed above and near said plurality of strings, each of said fingers able to be individually actuated by means of actuation between a retracted configuration in which it is away and disengaged away from one of said plurality of strings and an imparted configuration wherein it is imparted thereagainst, and a means of selection such that a piano player may select one of said fingers, and a means of actuation that can be actuated by a piano player such that a selected one of said fingers is imparted against at one of said plurality of strings as said piano player strikes a key associated therewith.

16. An acoustic effect impartment apparatus for use in a piano as claimed in claim 15, wherein said means of selection and/or means of actuation is operably selected and/or actuated via a wireless computing device.

17. A method of imparting an acoustic effect to a piano including a plurality of keys, a plurality of strings provided in corresponding relation to said keys and a plurality of hammers each responsive to an operation of any one of said keys to strike the string corresponding to the key, said method comprising a piano player causing actuation of a movable elongate member to move between a retracted configuration in which it is away and disengaged away from one of said plurality of strings and an imparted configuration where it is imparted thereagainst.

18. A method as claimed in claim 17, wherein said piano player causes actuation of said movable elongate member from a seated position.
